(19) United States
(12) Patent Application Publication
(10) Pub. No.: US 2024/0109453 A1
(43) Pub. Date: Apr. 4, 2024

(54) CHARGING DEVICE

(71) Applicant: TOYOTA JIDOSHA KABUSHIKI KAISHA, Toyota-shi (JP)

(72) Inventor: Masatoshi KIMATA, Toyota-shi (JP)

(73) Assignee: TOYOTA JIDOSHA KABUSHIKI KAISHA, Toyota-shi (JP)

(21) Appl. No.: 18/226,857

(22) Filed: Jul. 27, 2023

(30) Foreign Application Priority Data
Sep. 30, 2022 (JP) 2022-158358

(51) Int. Cl. B60L 53/67; B60L 53/62; B60L 58/12; B60L 58/22

(52) U.S. Cl. CPC B60L 53/67; B60L 53/62; B60L 58/12; B60L 58/22

(57) ABSTRACT

The charging device disclosed herein charges each of a plurality of connected battery electric vehicle to a first charge level. Subsequently, the charging device charges each of the plurality of battery electric vehicle to a second charge level greater than the first charge level. The first charge level is typically set to half the full charge level. According to this charging device, when half of the charging time until full charging has elapsed, charging of the subsequent battery electric vehicle is started. The time it takes to charge the first battery electric vehicle to full charge allows each of the two battery electric vehicle to be charged to half of full charge level and ready for use.

### CROSS-REFERENCE TO RELATED APPLICATION

This application claims priority to Japanese Patent Application No. 2022-158358 filed on Sep. 30, 2022, incorporated herein by reference in its entirety.

### BACKGROUND

### 1. Technical Field

The technique disclosed in the present disclosure relates to a charging device capable of charging batteries of a plurality of battery electric vehicles. Note that, in the present specification, for simplicity of explanation, “charging the battery of the battery electric vehicle” may be simply referred to as “charging the battery electric vehicle”.

### 2. Description of Related Art

Japanese Unexamined Patent Application Publication No. 2011-36096 (JP 2011-36096 A) discloses a charging device capable of charging a plurality of battery electric vehicles. In the charging device described in JP 2011-36096 A, priority is assigned to each of the battery electric vehicles, and the charging device charges the battery electric vehicles in order from the highest priority.

### SUMMARY

In the charging device described in JP 2011-36096 A, when it takes time to charge the first battery electric vehicle, it takes a considerable amount of time until charging of the next battery electric vehicle is started. For example, when it takes ten hours to charge the battery of the first battery electric vehicle to full charge, charging of the battery of the next battery electric vehicle is started after ten hours. It takes a considerable amount of time before the next battery electric vehicle becomes usable.

The charging device disclosed in the present specification charges each of a plurality of battery electric vehicles that is connected to a first charge level.

Subsequently, the charging device charges each of the battery electric vehicles a second charge level that is larger than the first charge level.

The first charge level is typically set to half the full charge level. According to the charging device above, when half of the charging time to full charge elapses, charging of the next battery electric vehicle is started. The second battery electric vehicle can be charged to some extent in the duration required to charge the first battery electric vehicle to full charge. That is, two battery electric vehicles can be made usable in the duration required to charge the first battery electric vehicle to full charge. According to the charging device disclosed in the present specification, it is possible to shorten time until the battery electric vehicles become usable.

Priority may be set to each of the battery electric vehicles, and the charging device may be configured to start charging from the battery electric vehicle with the highest priority.

The charging device may include an input device that receives an input of a priority by a user.

Details of the technique disclosed in the present specification and further modifications will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a charging device according to an embodiment;

FIG. 2 is a flowchart of a charging process executed by a controller of the charging device;

FIG. 3 is a flowchart of a charging process executed by the controller of the charging device (continuation of FIG. 2).

### DETAILED DESCRIPTION OF EMBODIMENTS

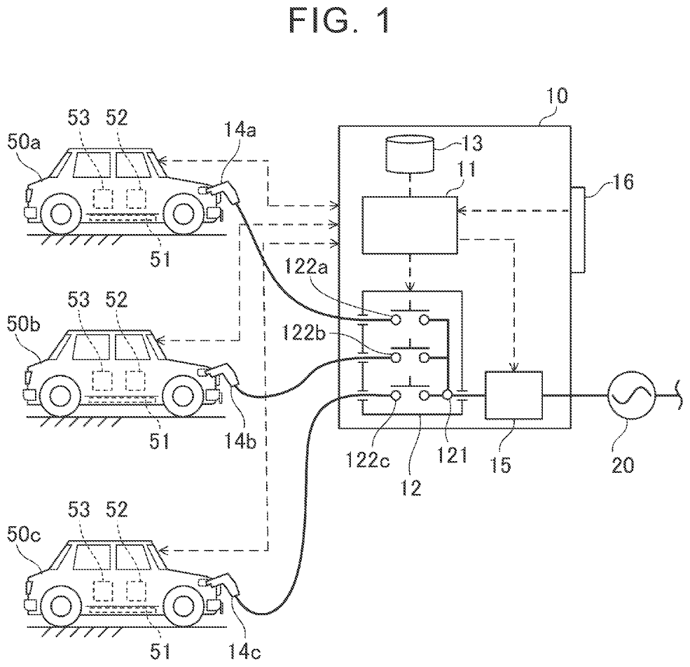

A charging device 10 according to an embodiment will be described with reference to the drawings. FIG. 1 is a block diagram of a charging device 10. The charging device 10 can connect and charge a plurality of battery electric vehicle. In the present specification, the term “battery electric vehicle” means a vehicle including a rechargeable battery. In FIG. 1, three battery electric vehicle 50a-50c are shown connected to the charging device 10. In the following, the phrase “to charge battery electric vehicle battery” may be referred to as “to dielectric battery electric vehicle”. In addition, battery electric vehicle 50a-50c may be collectively referred to as a battery electric vehicle 50.

Each of battery electric vehicle 50 includes a battery 51 that supplies electric power to a driving motor, a controller 52 that controls the battery 51 and the motor and communicates with an external device, and a storage device 53. The storage device 53 stores various programs and data. The stored data includes the identification of the own battery electric vehicle and the charge priorities (described later). The controller 52 can also communicate with the controller 11 of the charging device 10. Battery electric vehicle 50 may be the same type of motor vehicle or may be a different type of motor vehicle.

The charging device 10 of FIG. 1 includes a controller 11, a relay 12, a storage device 13, a power supply device 15, and an input device 16. The storage device 13 stores various programs and data executed by the controller 11.

The power supply device 15 is an Alternating Current/Direct Current (AC/DC) converter having an Alternating Current (AC end and a Direct Current (DC end, and is a device that converts AC power inputted to AC end into DC power and outputs the DC power from DC end. The power supply device 15 converts the AC power inputted to AC terminal into DC power suitable for charging the battery 51. AC terminal of the power supply device 15 is connected to an external AC power supply 20 (commercial power supply).

DC terminal of the power supply device 15 is connected to the input terminal 121 of the relay 12. The relay 12 is a switch that connects the input-terminal 121 to one of the three output terminals 122a-122c. The relay 12 is controlled by the controller 11.

Each of the charging plugs 14a, 14b, 14c is connected to each of the output terminals 122a, 122b, 122c of the relay 12. The charging plugs 14a-14c are connected to charging ports of battery electric vehicle 50a-50c. In FIG. 1, the charging plug 14a is connected to the charging port of battery electric vehicle 50a. The charging plug 14b (14c) is connected to a charging port of battery electric vehicle 50b (50c).

The controller 11 controls the relay 12, connects the input-terminal 121 to one of the output terminals 122a-122c, and drives the power supply device 15, whereby the battery 51 of battery electric vehicle 50 connected to one of the charging-plug 14a-14c can be charged. Hereinafter, the charging plugs 14a-14c may be collectively referred to as a charging plug 14.

The charging plug 14 is provided with a communication port. When the charging plug 14 is connected to battery electric vehicle 50, the controller 52 of battery electric vehicle 50 can communicate with the controller 11 of the charging device 10. The charging device 10 receives, from battery electric vehicle 50 controllers through the communication port of the charging plug 14, the vehicle identifier, the remaining power of the battery 51, and the charging priorities (described later). The controller 11 can associate the identifier of battery electric vehicle 50 with the number (14a-14c) of the charging plug according to which charging plug the identifier is received.

When a plurality of battery electric vehicles 50 is connected to the charging device 10, the controller 11 sequentially charges the high-priority vehicles. In addition, the charging device 10 does not charge battery electric vehicle to the full charge level at one time, but first charges all battery electric vehicle to the first charge level, and then charges all battery electric vehicle to the full charge level. By thus charging battery electric vehicle in two stages, a plurality of battery electric vehicle can be quickly used.

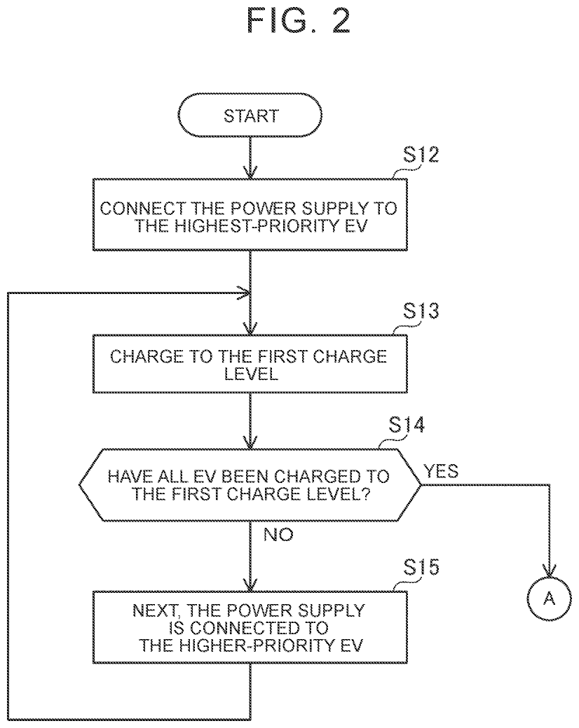

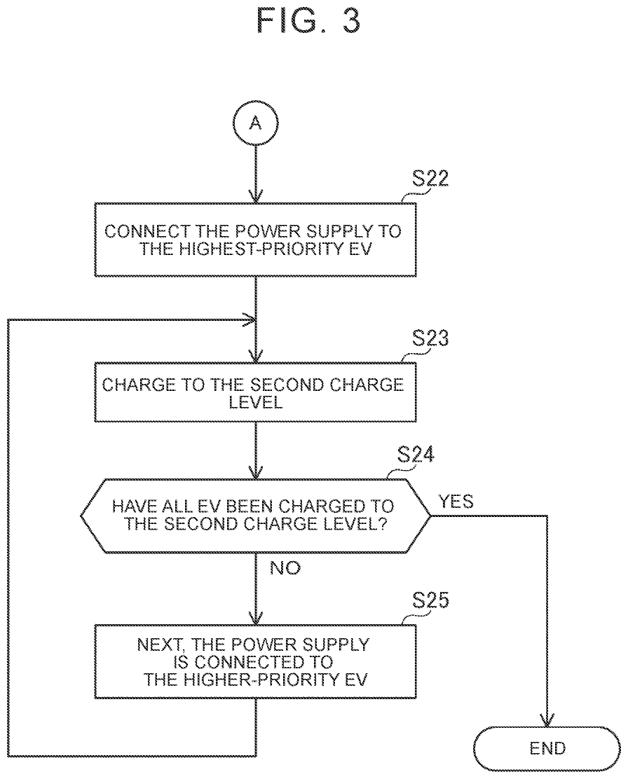

FIG. 2 and FIG. 3 show a flowchart of the charging process executed by the controller 11. In FIGS. 2 and 3, “EV” means battery electric vehicle.

The controller 11 connects battery electric vehicle having the highest priorities among the plurality of battery electric vehicles 50 connected to the charging device 10 to the power supply device 15 (S12). As described above, the controller 11 receives the priorities of the respective battery electric vehicles 50 via the communication ports of the charging plugs 14. The controller 11 selects the charging plug 14 connected to battery electric vehicle 50 having the highest priority based on the correspondence between the identifier and the charging plug and the priority assigned for each identifier. The controller 11 controls the relay 12 so as to connect the output terminal corresponding to the selected charging plug 14 among the output terminals 122a-122c of the relay 12 to the input terminal 121. In this way, the controller 11 connects the power supply device 15 to the highest-priority battery electric vehicle 50.

In addition, the controller 11 acquires the remaining capacity and the full charge level of the batteries 51 of the respective battery electric vehicle 50 via the communication ports. Then, the battery 51 is charged until the remaining capacity of battery 51 of battery electric vehicle 50 connected to the power supply device 15 reaches the first charge level (S13). The first charge level is set to half of the full charge level.

Subsequently, the controller 11 connects the next highest-priority battery electric vehicle 50 to the power supply device 15, and charges the batteries 51 of the connected battery electric vehicle 50 to the first charge level (S14:NO, S15, S13). The controller 11 charges all battery electric vehicles 50 to a first charge level (S14: NO, S15).

Once all battery electric vehicles 50 have been charged to the first charge level, the controller 11 connects the highest-priority battery electric vehicle 50 back to the power supply device 15 (S14:YES, S22). The controller 11 then charges the battery 51 until the remaining capacity of battery 51 of battery electric vehicle 50 connected to the power supply device 15 reaches the second charge level (S23). The second charge level is set to a value larger than the first charge level. The second charge level is set to, for example, a full charge level.

Subsequently, the controller 11 connects the next highest-priority battery electric vehicle 50 to the power supply device 15, and charges the batteries 51 of the connected battery electric vehicle 50 to the second charge level (S24:NO, S25, S23). When all battery electric vehicles 50 are charged to the second charge level, the controller 11 terminates the charging process (S24: YES, end).

Advantages of the charging device 10 are described. For example, assume that it takes 10 hours to charge battery electric vehicle 50 to full charge level and 5 hours to charge to half full charge level. When battery electric vehicle 50 with the highest priority is charged to full charge level with the first charge level, battery electric vehicle with the next priority starts to charge after 10 hours. After 10 hours, only one battery electric vehicle (the highest-priority battery electric vehicle) is available.

In the charging device 10 of the embodiment, the charging of the highest-priority battery electric vehicle is completed in five hours (however, the charging is up to half of the full charge level). Subsequently, the charge of battery electric vehicle of the subsequent priorities is started. Ten hours after starting to charge the highest-priority battery electric vehicle, both battery electric vehicle are charged to half of full charge level. The range is halved, but after 10 hours two battery electric vehicle are charged to half their full charge level and can be used. After 15 hours, three battery electric vehicle are available. By using the charging device 10 of the embodiment, it is possible to shorten the period until a plurality of battery electric vehicle can be used.

Points to be noted regarding the technique described in the embodiment will be described. The charging device 10 may be any device capable of connecting at least two battery electric vehicle. The charging device 10 includes a plurality of charging plugs, a power supply device, a relay, and a controller. The relay can switch the charging plug connected to the power supply device. The controller 11 communicates with battery electric vehicle via a communication port associated with the charge plug. Through this communication, the controller 11 recognizes the correspondence between battery electric vehicle to which the charging plug is connected and the charging plug. The controller 11 receives the priorities, the remaining power, and the full charge level from battery electric vehicle through the communication port.

The controller selects a charging plug to be connected to the power supply device in order according to the priority. When the battery of battery electric vehicle to which the charging plug is connected is charged to the first charge level, the controller 11 connects the charging plug connected to battery electric vehicle of the subsequent precedence to the power supply device. When all battery electric vehicle are charged to the first charge level, the controllers 11 connect the charge plugs connected to the highest-priority battery electric vehicle to the power supply. When the battery of battery electric vehicle to which the charging plug is connected is charged to the second charge level, the controller 11 connects the charging plug connected to battery electric vehicle of the subsequent precedence to the power supply device.

In the embodiment, the priorities are predetermined and stored in the respective battery electric vehicle 50. The priority may be input to the controller 11 by the user using the input device 16.

In the embodiment, the controller 11 selects battery electric vehicle to be charged according to predetermined priorities. The controller 11 may be prioritized based on the remaining power of the plurality of battery electric vehicle connected to the charging device 10. For example, the controller 11 may be charged in order from battery electric vehicle having a higher remaining power level. Such a charging order determination process may allow multiple vehicles to be charged to availability more quickly. The charge amount and the remaining power amount may be expressed as a ratio (percentage) to the full charge level, or may be expressed as an absolute value of the remaining power amount. The charge may be expressed in units of State of Charge (SOC).

In addition, the controller 11 may preferentially charge the plurality of connected battery electric vehicle from a battery electric vehicle in which the difference between the full charge level and the remaining power amount is small. According to such a charge order determination process, a plurality of battery electric vehicle can be used more quickly.

Alternatively, the controller 11 may preferentially initiate charging from a battery electric vehicle connected to the charging device 10 for a long period of time. For example, when the second battery electric vehicle is connected to the charging device 10 while the first battery electric vehicle is being charged, and thereafter the third battery electric vehicle is connected to the charging device 10, the charging of the second battery electric vehicle is started when the remaining power amount of the first battery electric vehicle reaches the first charge level. When the remaining power amount of the second battery electric vehicle reaches the first charge level, the controller 11 then begins charging the third battery electric vehicle. Such a charging order determination process causes a battery electric vehicle that is connected to the charging device for a long time to be charged first.

Battery electric vehicle connected to the charging device of the embodiment may be a vehicle having a rechargeable battery and a charging port for connecting the battery and the charging plug (charging device).

In the embodiment, the first charge level is set to half of the full charge level, and the second charge level is set to the full charge level. The first charge level may not be half of the full charge level and the second charge level may not be the full charge level. The second charge level may be larger than the first charge level.

When the second charge level is set to a value smaller than the full charge level, the controller 11 may charge all battery electric vehicle to the second charge level and then charge battery electric vehicle to the third charge amount in order according to the priorities. In this case, for example, the first charge level is set to half of the full charge level, the second charge level is set to ¾ of the full charge level, and the third charge amount is set to the full charge level.

Although the specific examples have been described in detail above, these are merely examples and do not limit the scope of claims. The techniques described in the claims include various modifications and alternations of the specific example illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A charging device that is able to charge a plurality of battery electric vehicles, wherein:
each of the battery electric vehicles that is connected is charged to a first electric energy; and
subsequently, each of the battery electric vehicles is charged to a second charge level that is larger than a first charge level.

2. The charging device according to claim 1, wherein:
priority is set to each of the battery electric vehicles; and
the charging device starts charging from the battery electric vehicle with the highest priority.

3. The charging device according to claim 1, wherein an input device that receives an input of a priority by a user is provided.

4. The charging device according to claim 1, wherein the first charge level is set to half of a full charge level of the battery electric vehicle.

5. The charging device according to claim 4, wherein the second charge level is set to the full charge level of the battery electric vehicle.
